(19) United States
(12) Patent Application Publication
(10) Pub. No.: US 2004/0117392 A1
(43) Pub. Date: Jun. 17, 2004

(54) Value mapping

(76) Inventor: Hermann Burgmeier, Nussloch (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/723,369

(22) Filed: Nov. 26, 2003

Related U.S. Application Data
(60) Provisional application No. 60/433,907, filed on Dec. 16, 2002.

(51) Int. Cl. G06F 17/00

(52) U.S. Cl. 707/100

(57) ABSTRACT

A system for value-mapping includes software and a graphical user interface including a value mapping table to allow comparisons of a mapped values in the graphical user interface. The value mapping table may include at least two columns and at least one row, in which at least one column represents a domain and at least one row includes a value, which may represent an object or data. A first value in a first domain can be mapped to a second value in a second domain. The first and second values can be in the same row of the value mapping table. The first value in the first domain may have a different representation of an object from the second value in the second domain. The first and second values may relate to the same object.

### CROSS-REFERENCE TO RELATED APPLICATIONS

This application claims benefit of U.S. Provisional Application No. 60/433,907, filed Dec. 16, 2002.

### TECHNICAL FIELD

The present disclosure relates to software object representation and value mapping.

### BACKGROUND

Software objects and data can be mapped or related to other objects and/or data using various techniques. Mappings include linking, relating, assigning, or connecting using logic embedded in various mechanisms, such as HyperText Transfer Protocol (HTTP) links, tags, identifiers or the like. Such mappings are particularly useful in enterprise software environments.

Conventional value mapping techniques may provide one or more users or programs with useful information and data. However, a problem may exist in how to visualize corresponding mapped values and how to perform the mapping of values quickly enough during execution of a program or process. The quantity of mapped values may be large for some domains and systems, thus potentially making an analysis of the mapped values complex and difficult for some users or programs. Searches performed with a shortcut keys or help keys can be too unspecific and may not narrow the search space effectively. There may be many values and relationships to search, and a detailed search may require significant time and resources on behalf of the searcher. Also, the presentation of mapped values to a user may provide a limited overview of mapping and mapping details. For example, in the case of hundreds of domains and hundreds of mapped values, only a few of the domains and/or a few of the values may be presented. The user may have difficulty in ascertaining the relationships of values across multiple domains.

In other cases, a user may become confused as changes occur to values and mappings. For example, if a first user changes the name of a value, a second user may not know if the mapping has also changed or if the re-named value will belong to a different domain. For instance, there may be a case with multiple domains in which each domain represents a business with multiple supervisor employees for projects. Each supervisor can be represented with a name, and each supervisor in each business can be mapped to a related supervisor in another business that is working on the same project. Say that one of the supervisors decided to change their name. If a first user changed the name (e.g., value identifier) of that supervisor, then a second user may not know if the supervisor working on the project is the same person or not.

In another example of the confusion that may result from changes to values and mappings, an enterprise may serve as a distribution center for a variety of products. A number of customers may order products from the enterprise. The enterprise may have different names or identifiers for the same product for different customers. Because the enterprise may have hundreds of products and many customers, the enterprise may want their employees to quickly and efficiently track and maintain products for their customers. The enterprise may also want their employees to allow the identification of their products to be tailored for each customer, while keeping track on the quantity, availability, and/or status of each product. Also, the presentation of product relations to a software user may provide a limited overview of relations and their details.

### SUMMARY

The present disclosure describes a computer-implemented system that, in one implementation, includes a number of databases. Each database is configured to store at least one domain of objects and each object is represented by a value. The computer-implemented system includes a graphical user interface configured to display a table having at least one row and two or more columns, in which each column represents one of the domains, and at least one row represents an object common to each domain displayed in the table. The computer-implemented system further includes a mapping engine configured to select a source domain from the number of databases. The mapping engine is also configured to generate a mapping of at least one value from the source domain to a value in at least one target domain from the number of databases based on an object that is common to the value in the source domain and the value in at least one target domain. The mapping engine may also be able to generate the table to represent the mapping, and apply the mapping for a user-initiated change to the table via the graphical user interface.

Each row may represent data and the mapping engine may be adapted to map data in a source domain to one or more target domains, in which the value may include a representation of an object and/or data. A first value in a first domain may be mapped to a second value in a second domain. The first and second values may be in the same row of the table. The table may be adapted to allow comparisons of a number of mapped values in the graphical user interface. The first value in the first domain can have a different representation of the object from the second value in the second domain. The first and second values may include a relation to the same object. The system may be adapted to allow a graphical interface user and/or a program to modify at least one of the mapped values.

The computer-implemented system may be further adapted to allow a graphical interface user and/or a program to select a source domain and a target domain. One or more mappings between values may be unaltered when one of the mapped values are modified. In one case, the mapping engine may maintain unaltered mappings between values when a column order and/or a row order are modified. The software may also be adapted to allow a graphical interface user and/or a program to modify at least one mapping between at least two values in the table.

The present disclosure also describes an article that includes a machine-readable medium storing instructions operable to cause a machine to perform operations that includes: presenting a graphical user interface in a display device; presenting a value mapping table in the graphical user interface; and presenting values of two or more domains in a side-by-side representation. The value mapping table includes one or more columns of domains and one or more rows of values. A first value from a first domain to a second value from a second domain is mapped and share a common row in the value mapping table. Each of the one or more rows of values represents an object, and the graphical user interface interacts with a mapping engine that maintains mappings of values from one or more databases.

The operations may also include a mapping of a value between two or more domains, and a modification of one or more values in the value mapping table. The mapping engine may maintain mappings of values when a value, a column, and/or a row are modified. The graphical user interface may further include one or more security features to permit one or more graphical interface users to edit a mapping, a value, and/or a domain. The graphical user interface security features may provide read-only access to one or more graphical interface users, and the graphical user interface security may be specific to a role of the user. One or more mapping rules of the article may be implemented with the value mapping table.

The operations may also include the following operations: providing a first icon in the graphical user interface to allow the graphical interface user to highlight a column; providing a second icon in the graphical user interface to allow the graphical interface user to hide a column; providing a third icon in the graphical user interface to allow the graphical interface user to view one or more details for a value; and displaying domain counterparts in a disparate graphical user interface. In another case, the operations may include the following: selecting a column in the value mapping table; moving the selected column to a different column location in the value mapping table; selecting a row in the value mapping table; and moving the selected row to a different row location in the value mapping table.

The present disclosure also describes a method that includes the following: presenting a value mapping table in a graphical user interface; mapping a number of related values in different domains in a common row; and maintaining mappings of the related values with a mapping engine. The value mapping table includes one or more rows and one or more columns, in which the one or more columns includes domains and the one or more rows includes values. The value mapping table presents an overview of mapped values in the graphical user interface, and the related values reside in one or more databases.

The systems and techniques described here may provide one or more of the following advantages. For example, a mapping table that shows relationships between values among multiple domains can provide an easy-to-understand view of those relationships to a graphical interface user. The mapping table can present an overview of mapped values in a side-by-side representation, and reduce the amount of time for a user to understand relationships among values across multiple domains. Hence, the mapping table can improve the efficiency and productivity of users who deal with the tracking of the mapped values of objects and data across multiple domains. Moreover, the names or identifiers of values can be changed and a mapping engine can keep track of the mappings. As a result, a graphical interface user does not have to manually adjust and track the mappings when changes are made to the value identifiers. Furthermore, multiple graphical interface users can view the mappings of the changed value identifiers and can easily determine relationships of values among multiple domains. The graphical user interface can allow one or more users to add and remove domains and objects, as well as changing the order of columns and rows, without changing the data or mappings.

Details of one or more implementations are set forth in the accompanying drawings and the description below. Other features and advantages will be apparent from the description and drawings, and from the claims.

### DRAWING DESCRIPTIONS

FIG. 1A is a diagram of an exemplary mapped value.

FIG. 1B is a diagram of an exemplary mapped value in an interface.

FIG. 2 is a diagram of an exemplary interface with a table.

FIGS. 3-4 are diagrams of exemplary mapped values.

FIG. 5A is a diagram of an exemplary graphical user interface.

FIG. 5B is an exemplary diagram of value mapping for FIG. 5A.

Like reference symbols in the various drawings indicate like elements.

### DETAILED DESCRIPTION

This document discloses various tasks, techniques, and interfaces for implementing a graphical interface user to view and/or map a value between two or more domains in a side-by-side representation.

The present disclosure provides techniques, tools, and interface(s) to present a clear and easy-to-understand value mapping graphical user interface (GUI). In one implementation, a graphical user interface may include a table. The table in the graphical user interface may represent a value mapping table. The value mapping table can allow for an easy comparison of two or more representations of an object or data in a single graphical user interface.

The table may include at least two columns and at least one row, in which each column may be represented with a domain and the row may have a value associated with each respective domain. The values may have different representations in each domain and may be mapped to data or an object. Related values may be within the same row for each respective domain. The one or more values may be modified by a user of the graphical interface (or a process or a program), or different pairs of source and target domains may be selected. The one or more values that were modified in the table can then be refreshed.

A mapping table that shows relationships between values among multiple domains can provide an easy-to-understand view of those relationships to a graphical interface user. The mapping table can present an overview of mapped values in a side-by-side representation, and reduce the amount of time for a user to understand relationships among values across multiple domains. Hence, the mapping table can improve the efficiency and productivity of users who deal with the tracking of the mapped values of objects and data across multiple domains.

A mapping engine can map an object or data in a row for one or more values across one or more domains. The mapping engine can track mappings, relationships, or links between an object and a domain, and/or an object and corresponding mapped values across one or more domains.

Value mapping (or, value transformation) may refer to replacing or substituting one or more values of a source domain with one or more corresponding values of one or more target domains. Value mapping may also refer to the process of identifying a value of a source domain and mapping that value to one or more corresponding values of one or more target domains.

A “domain” may refer to one or more values identifying a resource. The resources may include network resources (applications, printers, and so forth) for a group of users, and may include one or more sources or targets. A “domain” may also refer to a sphere of knowledge, information, or data identified by a name, in which the sphere of knowledge may be a collection of facts about, for example, some program, entities, network points or addresses. A “domain” may also refer to a group or a collection of values. For example, a domain may represent a collection of values in which the values may refer to people; especially a distinctive group of people with some shared interest.

The “value” may be a name, address, identifier, or property of data or information. A particular value from a source domain may be “mapped” (e.g., related or associated) onto one or more target values. The one or more target values may be within the same domain as the source domain or in different domains.

The terms “electronic document” and “document” can refer to a set of electronic data, including both electronic data stored in a file and electronic data received over a network. An electronic document does not necessarily, but may, correspond to a file. A document may be stored in a portion of a file that holds other documents, in a single file dedicated to the document in question, or in a set of coordinated files.

The term “object” may refer to information sources such as documents, reports, presentations, files and directories. An object may be associated with one or more domains. For example, an object may be on a server file system and two or more system users may have access to the object with a graphical user interface, such as a portal. An object may refer to both data and procedures to manipulate the data. An object may have different representations in different contexts. For example, an object may include data that refers to a person as a customer in one context and that same person as a co-worker in another context. The term “Mapping” may include linking, relating, assigning, or having logical connections between data or values. In general, value mapping or value transformation is symmetric. Also, values may be mapped in groups, and each of value mapped groups may be closed. In some cases, a globally unique identifier domain (GUID) is assigned to each group of mapped values. A typical system may include a relatively large number of value mapped groups.

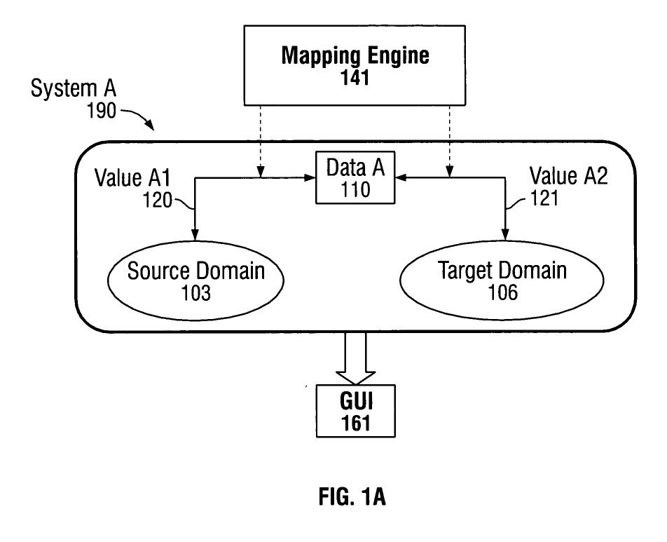

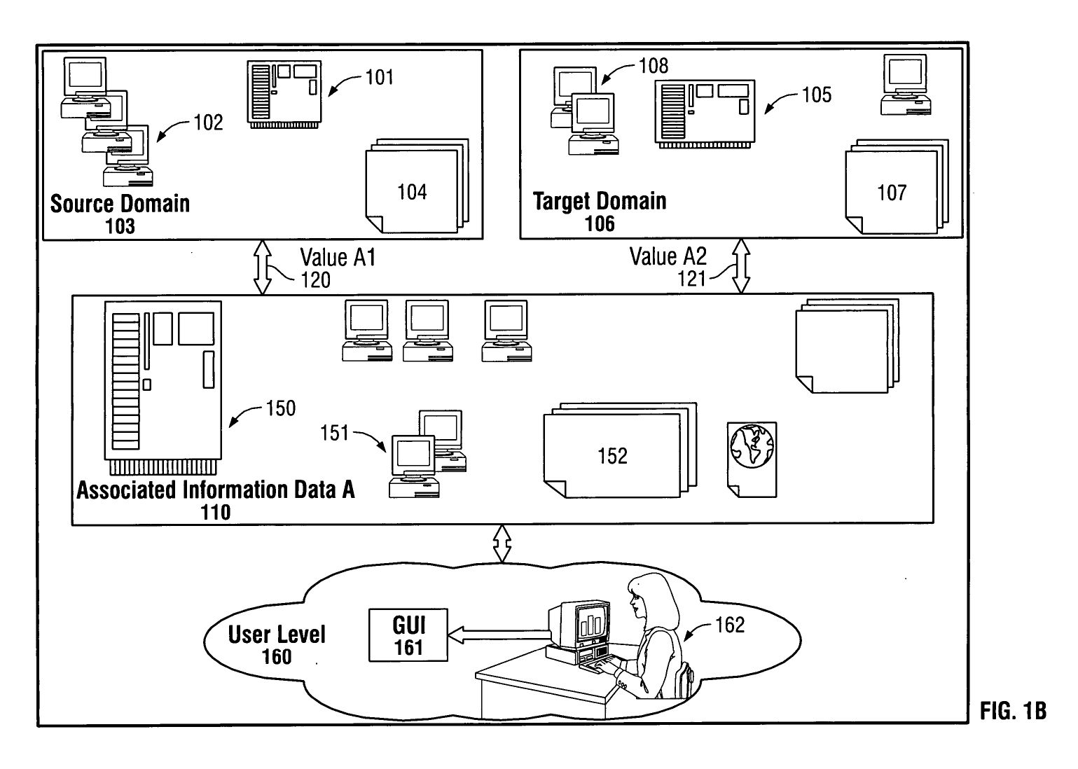

FIG. 1A is a diagram of an exemplary system 190 that has a source domain 103 and a target domain 106. The source domain 103 and target domain 106 may be related by data 110 that is related to both domains. The data 110 may represent, for example, an object or data. The related data or object may have different values 120, 121 in both domains 103, 106. The data 110 could also have the same value in both domains (e.g., Value A1 is the same as Value A2).

The process of value mapping may be implemented on a computer or device that includes a processor, a memory, and a storage medium. The storage medium may be used to store domain data and data for value mapping, and may also store machine-executable instructions that are executed by the processor out of the memory to perform user functions. Furthermore, each user device and/or computer may include an operating system. The mapping engine 141 may be used for mapping the object or data 110 in a source domain 103 to one or more target domains 106. The mapping engine 141 may be implemented in software and may reside in the storage medium. In FIG. 1A, the mapping engine 141 may keep track of the values 120, 121 between the data 110 and the mapped source and target domains 103, 106.

FIG. 1B shows an example of value mapping using two domains. A source domain 103 may have information residing on a physically distributed system, in which the information may reside on a database 101 and a network of computers 102. The information for the source domain may include one or more of the following: (1) business-specific information, such as sales information and human resource information; (2) data within objects, spreadsheets and text files 104; and/or (3) a group of business-related applications and logic. One or more values may be associated with the information in the source domain.

A target domain 106 may also have information residing on a physically distributed system that includes a database 105 and a network of computers 108. The source domain may have data, applications, and information that may be similar to the target domain. During the value mapping process, one or more values from the source domain 103 may be mapped to one or more corresponding values in the target domain 106. In this example, the values 120, 121 refer to the mappings between the associated information 110 and the source and target domains 103, 106. The mapped data or associated information 110 may reside on a database 150 or a network of computers 151 that may not be the same database 102, 105 and network of computers 102, 108 as in the source and target domains 103, 106. A user 162 may manually map, relate, link, or associate the source and target values in a graphical user interface 161. The user 162 may modify or edit the mapped values 120, 121 in a graphical user interface 161. Alternatively, a program or a process may associate or map corresponding values 120, 121 in the source and target domains 103, 106 and allow a user to view and/or modify those values in a graphical user interface 161.

The exemplary implementation described in FIG. 1B shows the domains as a physically distributed system. However, the domain may be within a closed system or residing on a single computer. The computer may or may not be a networked computer.

The domain may also be referred to as an attribute of an object or entity. For example, the domain may refer to a list of employees for an organization or a group of customers. In another illustration, a value referring to a product in a source domain 103 may refer to a component in a target domain 106. For example, a user 162 may associate or map a product from a distributor in the source domain 103 to a component in a manufacturing process in a target domain 106. If the distributor changes the name of the product, the user 162 (or a program or process) can update the new name in a graphical user interface. The mapping between the source and target domains remains the same, even though a value has been modified in one domain. The mapping rules for representing different objects, and the objects' corresponding mapped values, for different objects may be implemented using a value mapping table.

Any user 162, or a group of users, can easily view mapped values between domains in the value mapping table in a graphical user interface. In the case of a single user 162, for example, a mapping engine may be residing on the user's computer. In the case of multiple users, a mapping engine may be executing from a server system and accessed by the multiple used.

Even though one user is shown in FIG. 1B, the graphical user interface may be accessed by two or more users. The graphical user interface may use security features to permit certain users to edit (e.g., change, add, or delete) mappings, information, data, values, and/or domains. Other users may have read-only access to the graphical user interface and may not be allowed editorial access. The security features may be specific to a role of the user. For example, an account manager may be allowed to use the graphical user interface to edit the mapping of values of between different domains, in which the domains represent sales accounts and the values refer to products or goods. However, a customer call center representative may only have read access to the mappings and values presented in the graphical user interface.

In another example, a user may modify a value between two or more domains. Each domain may have a corresponding value, in which each value may relate to the same data or object. For example, a graphical user interface may have a value for two or more domains. In some domains, the mapped value may refer to a product. In other domains, the mapped value may refer to a component or part item in a manufacturing process. If the value of the component is modified by a user or a program, all related domains can keep their corresponding mapped value to the value of the modified component. The user can view the mapped values in a side-by-side comparison in a value mapping table in a graphical user interface 161.

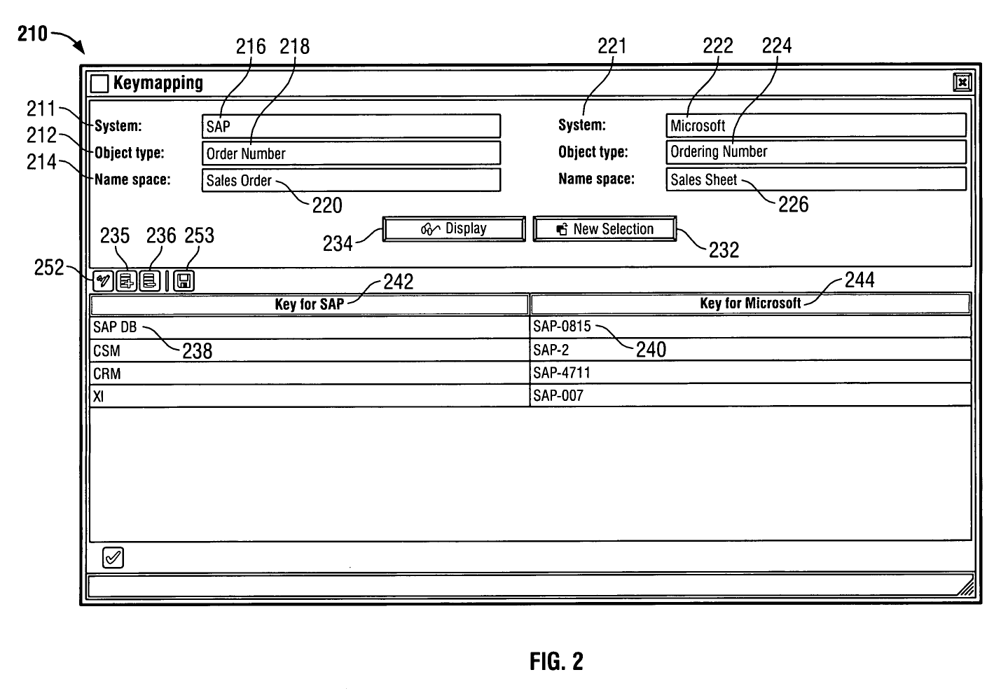

FIG. 2 shows an example of a graphical user interface 210 with a value mapping table. The exemplary graphical user interface 210 that may be displayed on a user's visual display device may include a purchase order number 220 mapped from a first organization 216 to a second organization 222. The graphical interface user can specify an object type 218, 224 and the name of the object 220, 226 for each organization 216, 222. In accordance with this example, the graphical user interface 210 includes a column 242, 244 corresponding to each of organizations 216, 222, respectively.

The columns in the value mapping table may refer to domains, and may be referred to as a column for “key values” or mapped values for a given domain. Even though domains are specified for each organization in this implementations, the domains 242, 244 could refer to systems 211, 221 within the same organization or may include two or more additional organizations (not shown), in which each organization includes one or more domains. The additional domains could be shown in additional columns.

The rows in the graphical user interface 210 may contain a value 238, 240 for each corresponding domain 242, 244. For example, value “SAP DB” 238 in one domain 242 can be mapped to value “SAP-0815” 240 in another domain 244 via mapping a common object or data. Other related values in other rows may be mapped in corresponding domains. If a user changes the name of a value in a domain, that renamed value can still be mapped to the same values in other domains. Each row may represent an object or data that is commonly mapped among various domains.

In this example, new values can be entered by user action, for example by selecting or clicking on an icon 232. The new selection icon 232 can allow a user to enter values in a new domain. Selection of the icon 232 can open another column for value entries. For example, selecting icon 232 enables entries into the input fields 216, 218, 220, 222, 224, 226. The user may also select icon 234 to disable new entries or disable modification of current entries in the input fields 216, 218, 220, 222, 224, 226.

The graphical user interface 210 can allow a user to display a column by selecting or clicking an icon 235. The displayed column may be highlighted in the interface 210 or the displayed column may be shown in another window or interface, such as a pop-up window. The user can select or click another icon 236 to hide, un-highlight, or close a window with a displayed column. The user can edit a value within a row for a column by selecting the value and editing the text.

The user may also view or edit one or more details, mappings, or metadata for a value by selecting an icon 252. For example, when the icon 252 is selected, values selected by the user may open in a pop-up window to display the one or more details, mappings, or metadata. The user may edit the one or more details, mappings, or metadata of the selected value in the pop-up window. Then the user may select the icon 252 a second time to pop-out or elevate the icon 252 to close the pop-up window. The user may select icon 253 to save one or more settings or modifications.

In an example, one or more mappings may relate to values for customers in a distribution enterprise environment, in which products are identified with values and each customer is represented with a domain. The value details displayed in a pop-up window, for example, may include the quantity, availability, and/or status of each product.

In one implementation, in order to cause the display of a counterpart of “Order Number” 218 within a database system (e.g., 150 in FIG. 1B) a user may click on an icon (not shown) and enter a system, object type and/or name space. A corresponding domain of the counterpart may be displayed and added to the same interface 210 or may be displayed in another interface, such as a pop-up window.

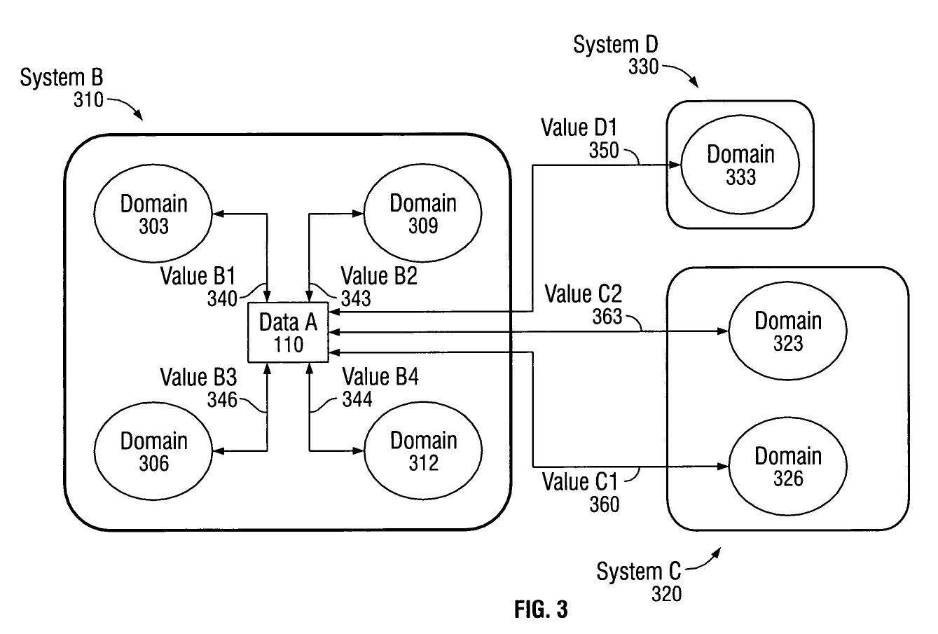

FIG. 3 illustrates another exemplary implementation of mapped values. The data 110 may be mapped to one or more domains 303, 306, 309, 312 within a system 310 with corresponding values 340, 346, 343, 344. The data 110 may have a different representation in each domain in the system 310. The data 100 may also be mapped to domains of other systems 330, 320. For example, the data 110 may have a mapping 350 to a domain 333 in System D 330 or mappings 363, 360 to one or more domains 323, 326 in System C 320. In one implementation, the data 110 may reside in a repository or a database in one system 310 and may be mapped to a system (e.g., 330) of another repository or database. The systems 310, 330 may be systems of different organizations or business groups within an organization. In another implementation, the data 110 may reside in a repository or a database in which the systems 310, 320, 330 are part of that repository or database.

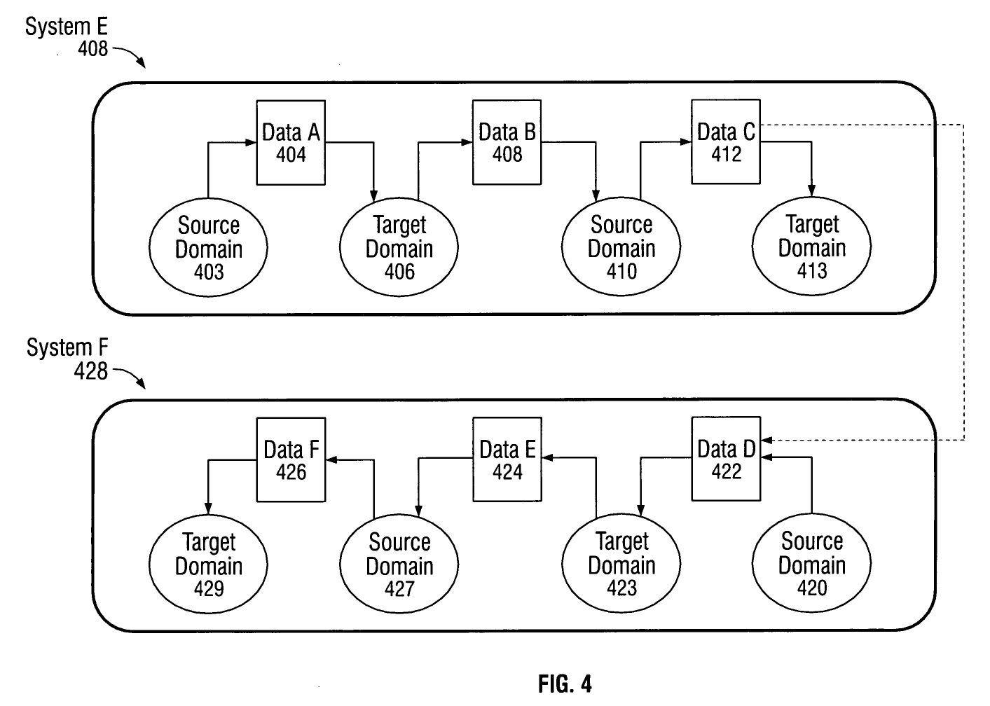

FIG. 4 illustrates other mapped values. A first data 404 in a system 408, System F, may map to a source domain 403 and a target domain 406. A second data 408 in the system 408 may map to a source domain 406 and a target domain 410 as well. The source domain 406 of the second mapped data 408 can be the target domain 406 of first mapped data 404. The target domain 410 of the second data 408 can be the source domain of a third data 412. In this manner, a group of various data 404, 408, 412, may be mapped via their corresponding source and target domains. In this implementation, the mapping may refer to one or more links in a hypertext system, or one or more pointers to metadata for a value. The metadata for the value may contain information regarding the source and target domains.

One or more values in the system 408 may also map to a value of a second system 428, System F. The second system 428 may have additional data 422, 424, 426 that are mapped via their corresponding domains 420, 423, 427, 429 as described in system E 408. In this fashion, values in two or more systems 408, 428 may be mapped via their respective source and target domains.

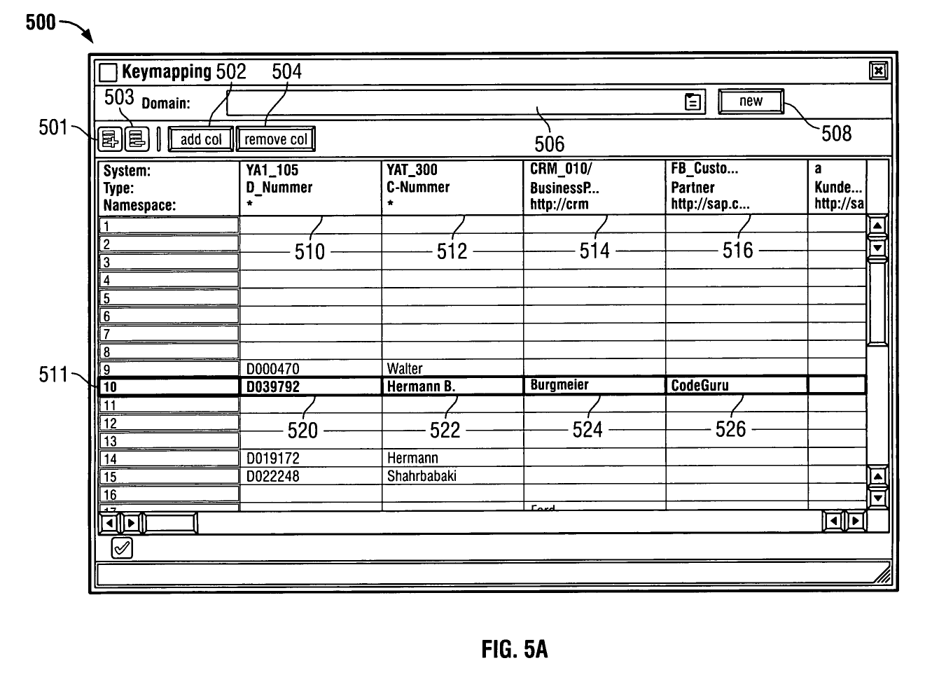

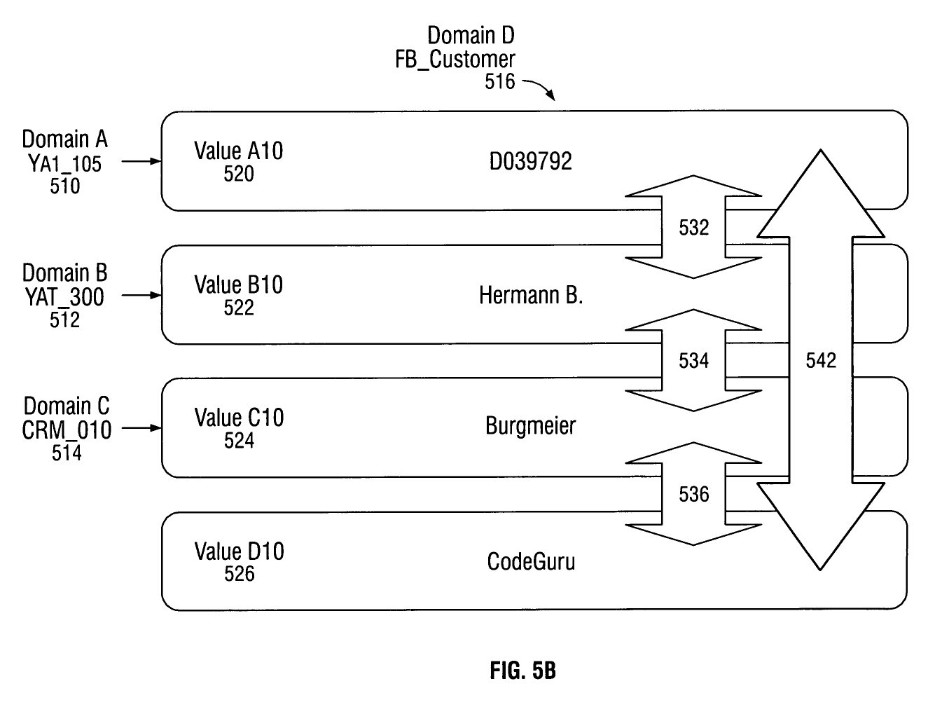

FIG. 5A is a diagram of an exemplary graphical user interface 500 to allow a user to view and/or map a value between two or more domains in a side-by-side representation. One or more domains 510, 512, 514, 516 in the interface 500 may be represented in a column. Each value in a column may be mapped in a row (e.g., row 10). When more than one value is in the same row, those values are mapped across their respective domains. For example, value 520, “D039792,” in domain 510, “YA_{—}105 D_Nummer,” may be mapped to value 522, “Hermann B.,” in domain 512. Value 520 may also be mapped to values 524 and 526 in domains 514 and 516, respectively. In this regard, all values for a given row are mapped to one another, and corresponding values from each domain can be displayed on one line. Each row may represent an object or data that is commonly mapped among various domains. Since there may be several domains in a system, the user of this system may choose the domains before any corresponding values are displayed. During viewing of values, the values may be modified by the user (or by a process or program), or different pairs of source and/or target domains may be selected.

The names or identifiers of values can be changed and a mapping engine (FIG. 1) can maintain track of the mappings. As a result, a graphical interface user does not have to manually adjust and track the mappings when changes are made to the value identifiers. Furthermore, multiple graphical interface users can view the mappings of the changed value identifiers and can easily determine relationships of values among multiple domains. The graphical user interface can allow one or more users to add and remove domains and objects, as well as changing the order of columns and rows, without changing the data or mappings.

In one implementation, the order or location of the domains in the value map may be switched and the value mapping can remain intact and unaltered. For example, a user may select column 516 and swap that column with column 512, so that column 516 is the second column in order from the right. However, the value 526, “CodeGuru” is still mapped to all of the other values within the same row 511 regardless of the order of the columns or domains.

The graphical user interface 500 allows a user to display a column by selecting or clicking one or more icons. The displayed column (e.g., column 512) may be highlighted in the interface 500 or the displayed column may be shown in another window or interface, such as a pop-up window (not shown). The user can select or click an icon 501 to add a row (or an icon 503 to remove a row) of value mappings in the table. The user can edit a value (e.g., 522) within a row for a column by selecting the value (e.g., 522) and editing the text (e.g., edit “Hermann B.”).

The graphical user interface 500 also can allow a user to select or click an icon 502 to add a column and/or select an icon 504 to delete a column. The user may also select an icon 508 to open a new domain workspace (e.g., a collection of domains) in the value map table. The user can enter a domain name and one or more values to relate to other domains. The new domain workspace may also be displayed in a pop-up window (not shown).

The graphical user interface 500 may also allow a user to locate an existing domain workspace (e.g., an existing collection of domains) or enter a domain workspace name in a text field 506. The domain workspace may reside within the same system as other domain workspaces, or the domain workspaces may reside in an external system. The field 506 may be a text field that interacts with a domain workspace search engine. The search engine may search one or more databases, repositories, and/or documents for the entered domain workspace. If the search engine locates the domain workspace, that domain workspace may be added to the value map table in the graphical user interface 500 (e.g., when a domain workspace is located, the table can be emptied and a new value mapping table with the domains in the selected workspace is displayed).

In another implementation, a user can switch between domain workspaces by entering a domain workspace name in text field 506. In another implementation, a user can switch between domain workspaces by a pull-down menu of domain workspaces, in which the pull-down menu of domain workspaces may include one or more domain workspaces as tree nodes.

The exemplary graphical user interface of FIG. 5A provides an easily-understandable value mapping view for a user. The value mapping table in the interface 500 may have a large number of values and/or domains. For instance, the interface 500 may have a hundred or more columns for domains and rows for values. The interface 500 with the value mapping table can help an interface user to more easily determine (1) which values belong to a particular domain and (2) which values are mapped to one another across two or more domains.

The graphical user interface 500 may also have another (e.g., second) text field box (not shown) in which a user can enter a full or partial name of a domain or value. A search can be performed on the entry with a search engine, and the interface 500 can jump or scroll to display a section of the value mapping table with that domain or value if it is found in the value mapping table.

FIG. 5B shows a diagram of an exemplary value mapping for FIG. 5A. In this implementation, each value for a domain is mapped to a value of another domain. For instance, value 520 for domain 510 “System A YA1_{—}105,” can be mapped to value 522 in domain 512, “System B YAT_{—}300,” and so on.

The domains in the graphical user interface 500 of FIG. 5A can be listed in any order. The relationships between values will remain, regardless of the domain order shown in the graphical user interface 500. For example, domain 510 can be switched 532 with domain 512 so that domain 512 is listed as the first domain. In another example, domain 516 can be swapped with domain 510, so that domain 516 is listed as the first domain listed in the value mapping table. In one case, the graphical user interface 500 may have one or more text fields (not shown) to enable a search of a domain, and to enable a new domain to be swapped or exchanged in place of a currently presented domain.

The domains illustrated in FIG. 5B can be in the same system or the domains can be within two or more disparate systems, including having a separate domain in each system. Although the domains shown in FIG. 5B may or may not belong to the same system, the disclosed value mapping process may allow for a relatively easy comparison of two or more representations of an object or data in a single visual screen or table.

The disclosed software described herein may use software and structures available from SAP AG of Walldorf, Germany. Instead of or in addition to SAP AG software, the disclosed software may coexist or operate with software and systems that are not provided by SAP AG For example, the disclosed software may include a software framework to work/operate seamlessly with other software tools made by Microsoft Corporation of Redmond, Wash.

Various implementations of the systems and techniques described here can be realized in digital electronic circuitry, integrated circuitry, specially designed ASICs (application specific integrated circuits), computer hardware, firmware, software, and/or combinations thereof. These various implementations can include one or more computer programs that are executable and/or interpretable on a programmable system including at least one programmable processor, which may be special or general purpose, coupled to receive data and instructions from, and to transmit data and instructions to, a storage system, at least one input device, and at least one output device.

The software (also known as programs, software tools or code) may include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on one or more computers each having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface, portal, or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), a wireless local area network (“WLAN”), a personal area network (“PAN”), a mobile communication network using a multiple access technology (e.g., a cellular phone network with Code Division Multiple Access, “CDMA”), and the Internet.

The computing system can include clients 151 (FIG. 1B) and servers 150. A client and server are generally remote from each other and typically interact through a communication network. The relationship of client and server arises by virtue of computer programs running on the respective computers and having a client-server relationship to each other.

Although only a few implementations have been described in detail above, other modifications are possible. There may be other value mapping scenarios not described. For example, a value may be mapped between domains in a graphical user interface in which the domains may refer to different industries (e.g., biotech, semiconductor, computer, energy, financial, health care, retail, entertainment, travel, etc.). Alternatively, a user may select a value in a table format (e.g., FIG. 5A) in a graphical user interface to display metadata associated with that value in a pop-up window. The user interfaces described above may be referred to as panels, palettes, pages, views, or portions of other interfaces. The logic flow depicted in FIG. 4 does not require the particular order shown, or sequential order, to achieve desirable results. The disclosed software may provide an easy solution to allow an interface user to have a personalized value identifier or value name that may be identified or named differently on the interface(s) of other users. For example, an interface user may name a value as “my secretary” when that same value may be identified as “William” in the interface of other users. Other implementations may be within the scope of the following claims.

What is claimed is:

1. A computer-implemented system comprising:
a plurality of databases, each database configured to store at least one domain of objects, wherein each object is represented by a value;
a graphical user interface configured to display a table having at least one row and two or more columns, wherein each column represents one of the domains, and the at least one row represents an object common to each domain displayed in the table; and
a mapping engine configured to select a source domain from the plurality of databases, generate a mapping of at least one value from the source domain to a value in at least one target domain from the plurality of databases based on an object that is common to the value in the source domain and the value in the at least one target domain, generate the table to represent the mapping, and apply the mapping for a user-initiated change to the table via the graphical user interface.

2. The computer-implemented system in accordance with claim 1 wherein each row further represents data and the mapping engine is further adapted to map data in a source domain to one or more target domains, wherein the value comprises a representation of any one of an object and data.

3. The computer-implemented system in accordance with claim 2 wherein a first value in a first domain is mapped to a second value in a second domain, wherein the first and second values are in the same row of the table, wherein the table is adapted to allow comparisons of a plurality of mapped values in the graphical user interface.

4. The computer-implemented system in accordance with claim 3 wherein the first value in the first domain has a different representation of the object from the second value in the second domain, wherein the first and second values comprises a relation to the same object.

5. The computer-implemented system in accordance with claim 4 wherein the system is adapted to allow any one of a graphical interface user and a program to modify at least one of the plurality of mapped values.

6. The computer-implemented system in accordance with claim 5 wherein the computer-implemented system is further adapted to allow any one of a graphical interface user and a program to select a source domain and a target domain.

7. The computer-implemented system in accordance with claim 5 wherein one or more mappings between values are unaltered when one of the plurality of mapped values are modified, wherein the mapping engine maintains unaltered mappings between values when any one of a column order, a row order, and a combination of a row order and a column order are modified.

8. The computer-implemented system in accordance with claim 4 wherein the software is adapted to allow any one of a graphical interface user and a program to modify at least one mapping between at least two values in the table.

9. An article comprising a machine-readable medium storing instructions operable to cause a machine to perform operations comprising:
presenting a graphical user interface in a display device;
presenting a value mapping table in the graphical user interface, the value mapping table comprising one or more columns of domains and one or more rows of values; and
presenting values of two or more domains in a side-by-side representation, wherein a first value from a first domain to a second value from a second domain are mapped and share a common row in the value mapping table, wherein each of the one or more rows of values represents an object, and wherein the graphical user interface interacts with a mapping engine that maintains mappings of values from one or more databases.

10. The article in accordance with claim 9 the operations further comprising:
mapping a value between two or more domains; and
modifying one or more values in the value mapping table, wherein the mapping engine maintains mappings of values when any one of a value, a column, and a row is modified.

11. The article in accordance with claim 10 wherein the graphical user interface further comprises one or more security features to permit one or more graphical interface users to edit any one of a mapping, a value, and a domain, wherein the graphical user interface security features comprise providing read-only access to one or more graphical interface users, wherein the graphical user interface security is specific to a role of the user.

12. The article in accordance with claim 9 wherein one or more mapping rules are implemented with the value mapping table.

13. The article in accordance with claim 9 the operations further comprising:
providing a first icon in the graphical user interface to allow the graphical interface user to highlight a column;
providing a second icon in the graphical user interface to allow the graphical interface user to hide a column;
providing a third icon in the graphical user interface to allow the graphical interface user to view one or more details for a value; and
displaying domain counterparts in a disparate graphical user interface.

14. The article in accordance with claim 9 the operations further comprising:
selecting a column in the value mapping table;
moving the selected column to a different column location in the value mapping table;
selecting a row in the value mapping table; and
moving the selected row to a different row location in the value mapping table.

15. A method comprising:
presenting a value mapping table in a graphical user interface, the value mapping table comprising one or more rows and one or more columns, wherein the one or more columns comprises domains and the one or more rows comprises values;
mapping a plurality of related values in different domains in a common row, wherein the value mapping table presents an overview of mapped values in the graphical user interface, wherein the plurality of related values reside in one or more databases; and
maintaining mappings of the plurality of related values with a mapping engine.

16. The method in accordance with claim 15, further comprising generating a mapping of at least one value from the source domain to a value in at least one target domain for the plurality of databases based on an object that is common to the mapped value in the source and target domains.

17. The method in accordance with claim 16 further comprising:
receiving an entry in a text field in the graphical user interface, wherein the entry comprises an identifier for any one of a domain and value;
searching for the entry with a search engine to locate the entry in the value mapping table; and
displaying a located entry in the graphical user interface.

18. The method in accordance with claim 16 further comprising switching a display of a domain among domains in the graphical user interface, the switching a display of a domain among domains comprising:
receiving a first domain entry in a text field in the graphical user interface;
presenting the first entered domain in a graphical user interface;
entering a second domain entry in the text field; and
presenting the second entered domain to the graphical interface user, wherein the second entered domain is presented in place of the first entered domain.

19. The method in accordance with claim 16 further comprising:
adding any one of a column and row to the value mapping table; and
deleting any one of a column and row to the value mapping table.

20. The method in accordance with claim 16 further comprising:
selecting an icon to open a new domain in the value mapping table;
entering a domain name in the value mapping table; and
entering a value in the value mapping table.
